(19) United States
(12) Patent Application Publication
(10) Pub. No.: US 2005/0065902 A1
(43) Pub. Date: Mar. 24, 2005

(54) Method for designing optimization algorithms integrating a time limit

(76) Inventors: Simon De Givry, Toulouse (FR); Youssef Hamadi, Cambridge (GB)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/496,513

(22) PCT Filed: Nov. 22, 2002
(86) PCT No.: PCT/FR02/04017

(30) Foreign Application Priority Data
Nov. 23, 2001 (FR) 01/15193

(51) Int. Cl. G06F 17/00; G06N 5/00

(52) U.S. Cl. 706/45

(57) ABSTRACT

The process of the invention essentially implements the following functions: a model (1), heuristics (2), a search scheme (3) chosen from among several, an exploration strategy (4) chosen from among several and a temporal strategy (5) chosen from among several, the temporal control (7) entailing the choice of a temporal strategy and the adjusting of the limits of each exploration strategy.

The present invention relates to a process for aiding the design of optimization algorithms incorporating a time limit. It is aimed at enhancing the framework of constraint programming through the introduction of an explicit temporal control into the search algorithms.

A constrained combinatorial optimization problem is defined by a set of decision variables taking values from among finite sets of values, by a set of constraints on the variables restricting the combinations of values permitted, and finally by a function, which is, for example, in the case of a minimization problem, a cost function (it would be a profit function in the case of a maximization problem). A solution to such a problem is an assignment of all the variables which satisfies all the constraints. An optimal solution corresponds to a solution having the smallest value of the cost function among the set of existing solutions. The solving of a combinatorial optimization problem consists in searching for the low-cost, if possible optimal solutions, or, as the case may be, in proving the absence of any solution.

A conventional example of a constrained combinatorial optimization problem is the problem of the coloring of a graph. A variable is associated with each vertex of the graph. The domain of values of the variables contains the available colors. A difference constraint connects each pair of variables whose vertices are linked by an edge. The cost function corresponds to the number of different colors used in the solution. The study of graph coloring problems serves in particular within the telecommunications sector, in respect of problems of allocating frequencies to radio links in an RF network. An analogy is made between colors and frequencies.

The complexity of the solving of combinatorial problems is often such that only the search for low-cost solutions is conceivable in a reasonable computation time.

A first observation related to complexity theory is that no efficient algorithm for searching for solutions exists which is generic, that is to say capable of efficiently solving all combinatorial problems. It is necessary to develop a specific algorithm for each class of problem. The performance of the algorithm depends mainly on the analysis of the problem and on the subtle use of the results of this analysis. For example, the result of the analysis may be a heuristic guiding the choice of values. In the case of coloring in, a simple heuristic consists in choosing first the color used most in the solution during construction. Likewise, the order of assignment of the vertices is important: to reduce the practical complexity of the search, it is necessary to begin with the vertices that are most connected to the vertices already assigned. From this observation it emerges that the design of search algorithms is a tricky task which requires dedicated tools. Constraint programming (CP) offers a technical framework for such tools.

Numerous optimization applications, in particular embedded real-time applications, have strict limits on the memory space and the computation time consumed as operational constraints. In general, the computation time limit pertains to all so-called on-line systems, that is to say those capable of reacting continuously to outside events. Such is the case for example with systems for rescheduling tasks subsequent to new requests or to events that modify the initial schedule.

A second observation is that the search algorithms existing in commercial CP tools (Ilog, Cosytec, etc.) do not explicitly incorporate the operational constraints cited above. It is up to the programmer of the algorithm to implement means to guarantee the memory and time limits. Moreover, he does not benefit from any aid for describing how his algorithm utilizes the time limit.

There are chiefly two classes of solution search algorithms: (i) global search methods and (ii) local search methods. The former use problem refinement mechanisms consisting in breaking a problem instance down into several independent subinstances (producing a decision tree) and in applying a filtering procedure that excludes partial assignments deemed to be unsatisfiable or suboptimal (constraints propagation procedure). The latter use mechanisms for transforming complete assignments (which do not necessarily comply with all the constraints). These two approaches may be combined: this gives the hybrid methods, consisting of several global and/or local searches.

In limited time, the global search performs a partial exploration of the tree. One then speaks of a partial search. Numerous algorithms have been published for exploring the tree intelligently. Mention may be made for example of the “Limited Discrepancy Search” algorithm [see reference No. 6 at the end of the description] which repeats a more and more complex search, beginning by exploring the nodes of the tree that are preferred by the value choice heuristic and then moving progressively away from these nodes. Another example is that of the “Realtime Heuristic Search” algorithm [see reference No. 8] which uses the time limit to adapt the depth of its forward search within an interleaved scheduling and execution context.

In the case of the local search, the latter adapts fairly easily to a time limit. Numerous parameters are involved in the adjustment of a local search. For example, the number of variables modified at each transformation. These parameters influence the performance of the algorithm as a function of time. Mention may be made of the simulated annealing algorithm [see reference No. 1], the convergence of whose scheme for decreasing the temperature can be adjusted so as to terminate as exactly as possible within the time allowed.

Finally the incorporation of time into a hybrid search involves apportioning the computational burden between the various global and local searches from which it is composed. The article “A Meta-Heuristic Factory for Vehicle Routing Problems (Meta-Programming for Meta-Heuristics)” [see reference No. 3] proposes the automatic construction of hybrid algorithms on the basis of a set of elementary search operators dedicated to the problems of vehicle rounds. Construction is done by a learning method based on a collection of instances and for a given computation time. The complexity of the hybrid algorithm generated is estimated. This makes it possible to keep only the combinations and the adjustments of operators which lead to an algorithm whose computation time sticks almost to the time limit.

Constraint programming (CP) offers a computer language for expressing constrained combinatorial optimization problems. It sharply separates the problem modeling phase, that is to say the description thereof in the form of variables and constraints, from the solutions search phase. Initially the CP tools placed the stress on the modeling phase by proposing a set of constraints having great expressibility. More recently, advances have been made with regard to the language aspect of the solutions search phase. The “Optimization Programming Language” (OPL) language from Ilog [see references No. 7 and No. 13) offers an advanced language dedicated to global and partial search methods. OPL possesses certain functionalities enabling a problem to be solved more efficiently in limited time: (i) strategies specifying an order of exploration and (ii) methods for limiting the complexity of a search.

Part of the research in Artificial Intelligence (AI) is concerned with the more realistic incorporation of time constraints into real-time systems [see reference No. 12]. The “anytime” algorithms form part of this thrust. An “anytime” algorithm is an algorithm capable of returning a solution at any instant (for example before the end of the search time allowed), and which improves the quality of its solution over time. Typically, solutions search algorithms are “anytime” by nature if the assumption is made that it is possible to yield a first solution, possibly partial, at any instant. Work in this field is concerned with the temporal control of the algorithms employed in AI.

Three modes of temporal control of a search algorithm are distinguished depending on the type of time constraint:
In the contractual mode, the time limit is known before conducting the search. It is imposed either dynamically by a request coming from outside, or statically by a system requirement. The search algorithm must best utilize the time allowed and must duly yield a solution.

In the interruptible mode, the time limit is unknown. The search will be interrupted while underway on request from outside.

The search algorithm must produce solutions of increasing quality over time. The performance of the algorithm is judged as a function of its curve of change of quality of the solutions. It is preferable for the quality to progress better at the start of a search than after.

In the autonomous mode, the time limit is unknown. It is the temporal control which determines the best instant to stop the search and yield a solution. This is the approach that is mainly studied for “anytime” algorithms [see reference No. 16].

The temporal control generally uses prior learning on the basis of experiments to carry out the selection and the adjustment of a search algorithm. [See reference No. 15] studies the temporal apportioning of a time limit among several components of a voice processing algorithm to optimize quality on output.

The present invention applies mainly to the contractual mode. It is possible to switch from the contractual mode to the interruptible mode [see for example reference No. 14].

Each global (or partial) search algorithm defines a decision tree exploration scheme. From each scheme it is possible to extract a temporal control procedure which is usually adapted to the interruptible mode (for example the “Limited Discrepancy Search” algorithm [see reference No. 6]) and more rarely to the contractual mode (for example the “Realtime Heuristic Search” algorithm [see reference No. 8]). The same is the case for local or hybrid search algorithms. However, the description of the temporal control is not based on established primitives that are generic for a set of temporal control procedures. The programmer is responsible for fully installing each temporal control.

Neither does CP contain such primitives for describing a temporal control procedure in contractual mode. There is no primitive in the existing CP systems which facilitates the expression of the relationship between a time limit and the selection and the adjustment of a search algorithm. Neither does the general framework of “anytime” algorithms specify how to formalize this relationship.

An object of the present invention is a process for aiding the design of optimization algorithms incorporating a time limit which provides a framework for more easily expressing a search algorithm and its temporal control, in particular in contractual mode, this process being able to extend the framework of constraint programming, and making it possible to more efficiently solve problems with a time limit.

The process according to the invention comprises the following functions:
a model defining the problem to be solved,
heuristics for guiding the choices of construction of a search tree,
a library of search primitives for describing how to construct a complete a priori search tree,
a library of primitives describing adjustable limits of exploration of the tree and highlighting the relevant adjustments, these adjustments advantageously being obtainable by learning,
a library of primitives describing various temporal sequencings of partial searches such as figuring in the aforesaid library of search primitives and describing the manner of adjusting the parameters of each search.

According to one aspect of the invention, the adjustments of the limits consist in indicating the branches to be explored preferentially in the search tree.

According to another aspect of the invention, the adjustments of the limits are made according to one of the following three modes: frozen, progressive or adaptive.

Thus, according to the invention, the incorporation of the time limit into an algorithm is done through the adjusting of parameters dimensioning the complexity of its search.

The present invention will be better understood on reading the detailed description of a mode of implementation, taken by way of nonlimiting example and illustrated by the appended diagram in which:

FIG. 1 is a diagram illustrating the main functions implemented by the invention and their mutual relations,

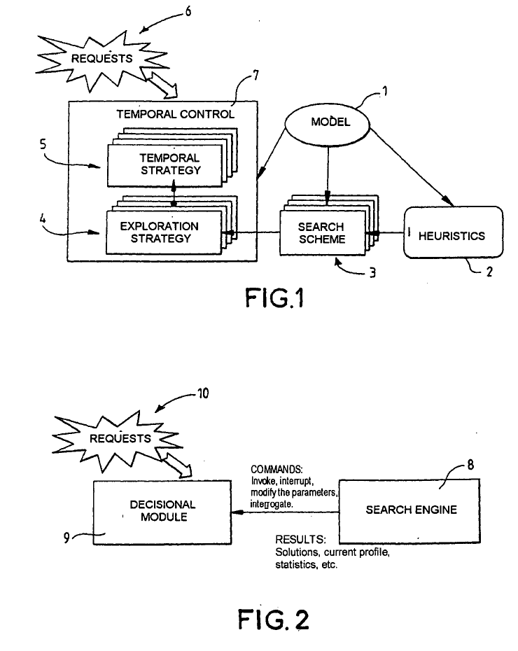

FIGS. 2 to 4 are diagrams illustrating the main functions implemented by prior art processes, and

FIG. 5 is a diagram illustrating the succession of steps implemented by the process of the invention.

The various functions implemented by the procedure for aiding the design of algorithms according to the invention will be described with reference to FIG. 1. These various functions are:
A model 1. It contains the definition of the problem to be solved in the form of a set of variables and of constraints.

A set 2 of heuristics. This is an extendable set of predefined functions for ordering the choices in the construction of a solution. For example, heuristics for guiding the choice of values. A set of primitives makes it possible to create new heuristics from existing heuristics. For example, the reversal of the order of a heuristic or the combining of two heuristics: in case of equality in the comparing of two choices by the first heuristic then comparing according to the second heuristic. The relationship between model and heuristics corresponds to the examination by the heuristics of the state of the current domains of the variables and of the structure of the constraint net so as to evaluate a choice.
A search scheme 3 (SS). It gives a structured representation of the search space. In the case of global searches, it describes the way to construct the decision tree, independently of any time constraint (complete a priori tree). The heuristics are used to parameterize this construction. The primitives associated with this component relate to the description of the choice points (the nodes of the tree), the combination of choice points and the minimization/maximization function, for example a cost/profit function. An example of a choice point is the enumeration of the values for a variable. An example of combining two choice points, A and B, is the sequencing: at each leaf of A, the search continues on B. The OPL language [see reference No. 7] possesses a set of such primitives. The relationship between model and search scheme allows dynamic construction of the tree, as a function of the current state of the model.
An exploration strategy 4 (ES). It specifies parameters controlling the complexity of the search. In the case of partial searches, these parameters pinpoint which part of the tree is to be explored. The ES therefore applies a certain number of limits on an SS. For example, a limit on the branching factor, applied to nodes of the tree. Certain references [see for example references No. 4 and No. 9] propose a set of primitives expressing these limits. A prior learning phase is necessary for determining the values of the parameters which are relevant. The list, sorted by increasing complexity, of the relevant values is called the “parameter adjustment policy”.
A temporal strategy 5 (TS). It describes the composition of ESs as a means of expression of the temporal control. A composition is a sequence of ESs, an interleaving of ESs or a combination of the two. This composition makes it possible to express most of the hybrid methods: <<Shuffling>> [see reference No. 2], <<Hybridations par coopération>> (hybridizations by cooperation) [see references No. 5 and No. 10], <<Interleaved Depth-First Search>> [see reference No. 11], etc. It should however be noted that this last example does not relate to a hybrid algorithm. It utilizes an idea specific to local searches, namely of diversifying the search by apportioning the computational burden over several subsearches performed in a quasi-simultaneous manner by an interleaving procedure. Each ES contributes to improving the quality of the solution. The solutions are shared among the ESs through a “solution log”. A “temporal apportioning policy” enhances a composition by indicating how to apportion a time limit to the ESs of the composition [see reference No. 5]. For example, an equitable apportioning of the time between the ESs of a sequence. Thus each ES will have its own time limit allowing it to control its exploration. The TS also specifies the mode of adjustment of the parameters of each ES: frozen, progressive or adaptive adjustment [see reference No. 4].
Requests 6. Coming from outside the system, the requests ask for the time-constrained solving of a combinatorial problem. Specifically, the requests envisaged (associated with a primitive) are those of on-line systems:
   Initiate a search with or without a time limit.
   Suspend, continue or stop a search.
   Widen or reduce the time limit of a search.
   Give information about the state of progress of the search.
A temporal control 7 (TC). The type of request imposes the mode of temporal control (contractual or interruptible). The interruptible mode is simulated by a succession of activations of the contractual mode with an increasing time limit. As a function of the time limit and of an analysis of the model, the TC selects a TS from a list of available TSs. The selection rules are determined by a prior learning phase. The TC has at its disposal tools estimating the time to perform a search, the quality of a solution (distance to the optimum) and the change in the quality of the solutions (“performance profiles”). These tools give state of progress information for a user of the system. They are also used for the adaptive adjustment of the parameters of an ES. They could also serve in the case of the autonomous mode of the temporal control. It is also the temporal control which receives and incorporates the requests during the search [see reference No. 5].

It should be noted that each component possesses a set of primitives facilitating the expression of a search algorithm incorporating a time limit. The TS and ES components make it possible to form the relationship between a time limit and the adjustment of a search algorithm. These characteristics are important characteristics of the invention (see FIG. 5, described hereinbelow).

FIG. 2 shows the general architecture of an on-line optimization system. It depicts two things essentially. On the one hand the search engine 8 which actually solves the current problem, on the other hand the decisional module 9 which drives the search and which receives outside requests 10. The decisional module instructs (instructions such as: invoke a search, interrupt it, modify the parameters, interrogate the search engine), the search engine provides results in return (solutions, current profile, statistics, etc.) [see reference No. 5]. This architecture does not specify the way to control the search, nor how to express this control.

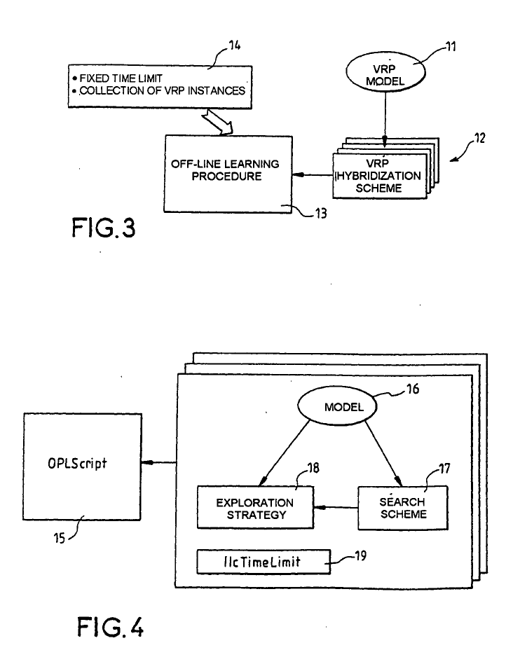

FIG. 3 shows the architecture used by reference No. 3. This architecture comprises: a model 11, a hybridization scheme 12, a learning procedure 13 and input data 14 which include a fixed time limit and a collection of instances for solving just the classical problem of vehicle rounds (delivery lorries for example), so-called VRPs. In this architecture, the temporal control is static. It involves generating an algorithm which performs averagely for a collection of instances representative of the problem to be solved and for a fixed time limit. This architecture is very specific for the following reasons: a single class of problem is treated (classical problem of vehicle rounds), the type of request is very limited (single time limit) and the temporal control of the algorithm is independent of the instance in progress.

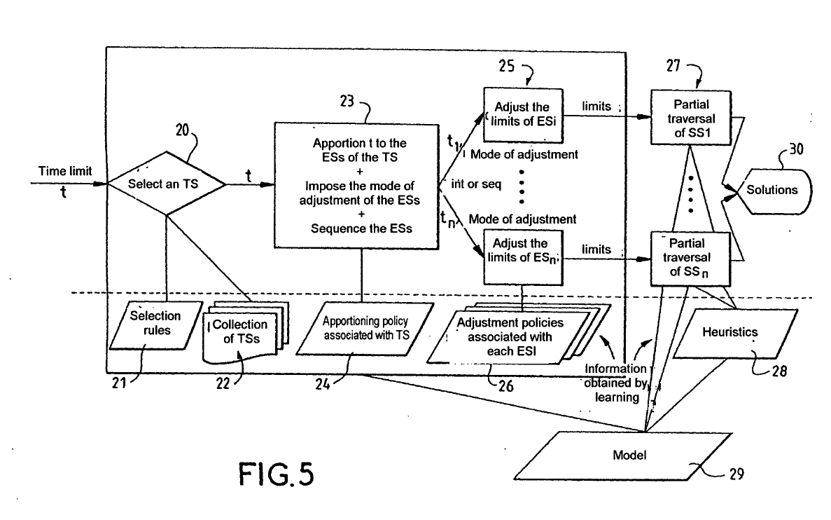

FIG. 4 shows the architecture of the OPL language [see references No. 7 and No. 13]. The component 15 “OPLScript” makes it possible to carry out a sequence of searches pertaining to models 16 which may be different. The searches are described by a search scheme 17 and an exploration strategy 18. OPL has no tool or primitive at its disposal which incorporates a time limit explicitly, with the exception of the primitive 19 “IIcTimeLimit” which has no effect on the adjustment of the search. This is why this component is clearly differentiated from the TS component of the present invention. The component 18 is different from the ES component of the present invention since this component 18 additionally offers the possibility of defining an order of traversal of the nodes of the tree. On the other hand, it does not make the assumption of explicit parameterization of the complexity of the search (absence of “parameter adjustment policy”).

Represented in FIG. 5 is a time chart showing how the various functions represented in FIG. 1 cooperate with one another. The outside environment fixes a time limit t for the search. As appropriate, this time limit may be modified during the search. The search procedure having been invoked, with this time limit, at 20, there is selection of a temporal strategy TS, which, by calling upon selection rules 21, chooses a TS from among a collection 22 of TSs. At 23, the time limit t is apportioned (t₁ to tₙ) to the various exploration strategies ES of the TS selected as a function of its associated “apportioning policy” 24. The mode of adjustment of the ESs and the sequencing of the ESs are also imposed by the TS selected. There follows, at 25, the adjustment of the limits of the n different ESs (ES₁ to ESₙ) as a function of the “adjustment policies” associated with each particular ES (ESᵢ) 26, of the mode of adjustment imposed by the TS and of the time allotted (tᵢ). The various ESs having been adjusted, the corresponding exploration limits each determine a partial traversal of SS (at 27), based on the heuristics 28 and the model 29. The execution of the various partial traversals is done in sequence (primitive “seq”) or interleaved (primitive “int”). This is controlled at 23, according to the TS selected. This results in (at 30) the production of one or more solutions, or even of none if the computation time is insufficient or if the problem is insoluble. It will be noted that the data of the elements 21, 22, 24, 26 and 28 are obtained by learning, not described by the invention.

In conclusion, the present invention makes it possible to:
Offer a framework for expressing search algorithms incorporating a time limit. This framework must facilitate the reading and the maintenance of such algorithms.
Propose a modular architecture for specifying such algorithms, with the possibility of reusing parts of the algorithm that arise from the various components, thus promoting monetary savings.
Incorporate the time limit dynamically to get a good adequacy of the algorithm to the time allowed and to the instance and possibly profit from advances in hardware platforms.
Extend the field of application of constraint programming to on-line problems.

### REFERENCES

1.—Aarts & Korst1989

E. Aarts, J. Korst. Simulated Annealing and Boltzmann Machines: a Stochastic Approach to Combinatorial Optimization and Neural Network. John Wiley & Sons, 1989.
2.—Applegate & Cook1991

D. Applegate, W. Cook. A computational study of the job-shop scheduling problem. ORSA Journal On Computing, 3(2):149-156, 1991.
3.—Caseau et al. 1999

Y. Caseau, F. Laburthe, G. Silverstein. A Meta-Heuristic Factory for Vehicle Routing Problems (Meta-Programming for Meta-Heuristics). In Proc. of CP-99, pages 144-158, Alexandria, Va., 1999.
4.—Givry et al. 1999

Simon de Givry, Pierre Savéant, Jean Jourdan. Optimisation combinatoire en temps limité: Depth first branch and bound adaptatif. In Proc. of JFPLC-99, pages 161-178, Lyons, France, 1999.
5.—Givry et al. 2000

S. de Givry, Y. Hamadi, J. Jourdan, J. Mattioli, M. Lemaître, G. Verfaillie, A. Aggoun, I. Gouachi, T. Benoist, E. Bourreau, F. X. Josset, F. Laburthe, B. Rottembourg, P. Boizumault, P. David, R. Debruyne, N. Jussien, S. Loudni, S. Bourgault, M. Lauvergne. Environnement d'optimisation en ligne dédié télécom. [Environment for telecom. dedicated online optimization] Technical report, Thales, ONERA, Cosystec, Bouygues, Ecole des Mines de Nantes and France Télécom, November 2000. Sub-project report 1.
6.—Harvey & Ginsberg1995

William D. Harvey, Matthew L. Ginsberg. Limited discrepancy search. In Proc. of IJCAI-95, pages 607-613, Montreal, Canada, 1995.
7.—Hentenryck1999

P. Van Hentenryck. OPL: The Optimization Programming Language. The MIT Press, Cambridge, Mass., 1999.
8.—Korf1990

Richard E. Korf. Real-time heuristic search. Artificial Intelligence, 42:189-211, 1990.
9.—Laburthe1998

François Laburthe. SaLSA: a language for search algorithms. In Proc. of CP-98, pages 310-324, Pisa, Italy, Oct. 26-30 1998.
10.—Lobjois & Lemaître1997

L. Lobjois, M. Lemaître. Coopération entre méthodes complètes et incomplètes pour la résolution de (V)CSP: une tentative d'inventaire [Cooperation between complete and incomplete methods for the resolution of (V)CSP: an inventory approach]. In Proc. of JNPC-97, pages 67-73, Rennes, France, 1997.
11.—Meseguer1997

Meseguer, P. (1997). Interleaved depth-first search. In Proc. of IJCAI-97, Nagoya, Japan, pp. 1382-1387.
12.—Musliner et al. 1995

David J. Musliner, James A. Hendler, Ashok K. Agrawala, Edmund H. Durfee, Jay K. Strosnider, C. J. Paul. The challenges of real-time AI. IEEE Computer, 28(1):58-66, January 1995.
13.—Perron1999

L. Perron. Search Procedures and Parallelism in Constraint Programming. In Proc. of CP-99, pages 346-360, Alexandria, Va., 1999.
14.—Russell & Zilberstein1991

S. J. Russell, S. Zilberstein. Composing real-time systems. In Proc. of IJCAI-91, pages 212-217, Sidney, Australia, 1991.
15.—Zilberstein1993

Shlomo Zilberstein. Operational Rationality through Compilation of Anytime Algorithms. PhD thesis, University of California, Berkeley, 1993.
16.—Zilberstein1996

Shlomo Zilberstein. Using Anytime Algorithms in Intelligent Systems. AI Magazine, 17(3):73-83, 1996.

1. A process for aiding the design of optimization algorithms incorporating a time limit, which process implements the following functions:
a model defining the problem to be solved,
heuristics for guiding the choices of construction of a search tree,
a library of search primitives for describing how to construct a complete a priori search tree,
a library of primitives describing adjustable limits of exploration of the tree and highlighting the relevant adjustments,
a library of primitives describing various temporal sequencings of partial searches such as figuring in the aforesaid library of search primitives and describing the manner of adjusting the parameters of each search.

2. The process as claimed in claim 1, wherein the adjustments of the limits consist in indicating the branches to be explored preferentially in the search tree.

3. The process as claimed in claim 1, wherein the searches are made according to one of the following three modes: frozen, progressive or adaptive.

4. The process as claimed in claim 1, wherein the incorporation of the time limit into an algorithm is done through the adjusting of parameters dimensioning the complexity of its search.

5. The process as claimed in claim 1, wherein the selection of a temporal strategy calls upon selection rules and chooses a strategy from a collection of temporal strategies.

6. The process as claimed in claim 5, wherein an apportioning policy associated with a selected temporal strategy apportions the time limit to the various exploration strategies of the selected temporal strategy.

7. The process as claimed in claim 5, wherein the selected temporal strategy composes the mode of adjustment of the exploration strategies and their sequencing.

8. The process as claimed in claim 5, wherein adjustment policies associated with each exploration strategy provide for the adjustment of the limits of the various exploration strategies.

9. The process as claimed in claim 8, wherein, the various exploration strategies being adjusted, the corresponding limits of exploration each determine a partial traversal of a search strategy based on the heuristics and the model.

10. The process as claimed in claim 8, wherein the data of the selection rules, of the temporal strategies, of the apportioning policy, of the adjustment policies associated with each exploration strategy, and of the heuristics are obtained by learning and experimentation.

11. The process as claimed in claim 2, wherein the searches are made according to one of the following three modes: frozen, progressive or adaptive.

12. The process as claimed in claim 2, wherein the incorporation of the time limit into an algorithm is done through the adjusting of parameters dimensioning the complexity of its search.

13. The process as claimed in claim 3, wherein the incorporation of the time limit into an algorithm is done through the adjusting of parameters dimensioning the complexity of its search.

14. The process as claimed in claim 2, wherein the selection of a temporal strategy calls upon selection rules and chooses a strategy from a collection of temporal strategies.

15. The process as claimed in claim 3, wherein the selection of a temporal strategy calls upon selection rules and chooses a strategy from a collection of temporal strategies.

16. The process as claimed in claim 4, wherein the selection of a temporal strategy calls upon selection rules and chooses a strategy from a collection of temporal strategies.

17. The process as claimed in claim 6, wherein the selected temporal strategy composes the mode of adjustment of the exploration strategies and their sequencing.

18. The process as claimed in claim 6, wherein adjustment policies associated with each exploration strategy provide for the adjustment of the limits of the various exploration strategies.

19. The process as claimed in claim 7, wherein adjustment policies associated with each exploration strategy provide for the adjustment of the limits of the various exploration strategies.

20. The process as claimed in claim 9, wherein the data of the selection rules, of the temporal strategies, of the apportioning policy, of the adjustment policies associated with each exploration strategy, and of the heuristics are obtained by learning and experimentation.
